(19) United States
(12) Patent Application Publication
(10) Pub. No.: US 2008/0131089 A1
(43) Pub. Date: Jun. 5, 2008

(54) Data Recording/Reproducing Device

(76) Inventor: Masaki Toyokura, Hyogo (JP)

Correspondence Address: MCDERMOTT WILL & EMERY LLP, 600 13TH STREET, NW, WASHINGTON, DC, 20005-3096, US

(21) Appl. No.: 11/794,955

(22) PCT Filed: Sep. 8, 2006
(86) PCT No.: PCT/JP06/17878

§ 371 Date: Jul. 10, 2007

(30) Foreign Application Priority Data
Sep. 22, 2005 (JP) 2005-275968

(51) Int. Cl. H04N 5/92

(52) U.S. Cl. 386/124; 386/E05.003

(57) ABSTRACT

A data recording/reproducing device includes a transport stream decoder for decoding a transport stream and outputting a resultant signal; a program stream encoder for obtaining a program stream by encoding the signal output from the transport stream decoder and outputting the program stream; and a system control unit for controlling the transport stream decoder and the program stream encoder to execute TS-PS conversion. In consideration of priority of processing of the TS-PS conversion, the system control unit allows the TS-PS conversion to be executed when both of the transport stream decoder and the program stream encoder are available for the TS-PS conversion.

### TECHNICAL FIELD

The present invention relates to a data recording/reproducing device for converting a transport stream (TS) used in digital broadcasting or the like into a program stream (PS) used in a DVD (digital versatile disc) or the like.

### BACKGROUND ART

In accordance with the spread of digital televisions (DTVs) for digital terrestrial television broadcasting or the like, DVD/HDD (hard disk drive) recorders having a DTV receiving function have been available. Coding data formats for the DTV and the DVD are constructed on the basis of the MPEG-2 (moving picture experts group-2) coding technique, and a TS is used for a DTV and a PS is used for a DVD. The general technique of the MPEG2 is standardized in ISO/IEC13818-1, 2 and 3, and the TS and PS are described in detail in ISO/IEC13818-1.

The process flow for the TS and PS of the MPEG-2 will now be simply described. First, audio or video data is compressed by corresponding compressing technique into an elementary stream (ES), and a time stamp and information of the ES are added as a PES header, so as to construct a packetized elementary stream (PES).

The PES of the audio data or the video data is divided, and a transport header including a synchronization byte and media identification information (PID) is added to each divided data, so as to construct a transport packet of 188 bytes. Such transport packets are collected to be changed into a stream, and thus, a TS is constructed. Also, when a pack of collected PESs and a pack header including system clock reference (SCR), a multiplexing speed and the like is changed into a stream, a PS is constructed. A TS uses a packet with a small fixed length for attaining high error resistance suitably for the broadcasting, and a plurality of programs can be multiplexed. In a DTV for the digital terrestrial broadcasting or the like, such a TS is used. A PS is used for a recording medium, and is characterized by a small ratio of a data amount of a header and has high data efficiency. Such a PS is used in a DVD-Video in which a movie is recorded or a readable/rewritable DVD or the like.

An example of a receiving system for the DTV is described in Patent Document 1 below. This publication does not, however, describe in detail the functions of both the DTV and a DVD/HDD recorder and TS-PS conversion for converting a TS into a PS.

A DVD/HDD recorder having the DTV receiving function should have not only a function to receive TSs transmitted from a broadcast station and to reproduce/record them but also a function to record/reproduce PSs in/from a DVD. A function to be further added may be a function to convert a received TS into a PS for recording it in a DVD.

FIG. 11 is a flowchart for showing process flow of conventional TS-PS conversion. In step S90 of FIG. 11, a TS-PS conversion request input through an operation by a user is accepted. Next in step S92, processing utilizing a TS decoder or a PS encoder is checked. In other words, it is determined whether or not a TS decoder or a PS encoder is operating. When neither the TS decoder nor the PS encoder is operating, the procedure proceeds to step S94, and when either of the TS decoder and the PS encoder is operating, the procedure proceeds to step S96.

In step S94, the TS-PS conversion is executed by using the TS decoder and the PS encoder. In step S96, the acceptance of the TS-PS conversion is cancelled, and the user is informed that the TS-PS conversion cannot be performed.

In this manner, resource use condition is confirmed for avoiding conflict of resources, and thus the TS-PS conversion can be executed. When TS decoding or PS encoding is to be performed through an operation while executing the TS-PS conversion processing, the resource use condition is similarly checked, and if the resource is being used, acceptance of the operation is cancelled.

Patent Document 1: Japanese Laid-Open Patent Publication No. 2004-129121

### DISCLOSURE OF THE INVENTION

### Problems to be Solved by the Invention

In the method shown in FIG. 11, the TS-PS conversion processing is once accepted, and if there arises conflict in resources, the acceptance of the TS-PS conversion processing is cancelled. Therefore, in order to perform the TS-PS conversion, it is necessary for a user to wait until the end of the use of the TS decoder or the PS encoder and to perform an operation for activating the TS-PS conversion processing again. Also, in order to watch a program of the digital broadcasting by using the TS decoder or to record a program of analog broadcasting by using the PS encoder during the TS-PS conversion, it is necessary to halt the TS-PS conversion through an operation.

An object of the invention is executing the TS-PS conversion processing without performing the operation again even when there arises conflict in a necessary resource between the TS-PS conversion processing and another processing.

### Means for Solving the Problems

The data recording/reproducing device of this invention includes a transport stream decoder for decoding a transport stream and outputting a resultant signal; a program stream encoder for obtaining a program stream by encoding the signal output from the transport stream decoder and outputting the program stream; a stream control unit for reading the transport stream from a recording medium, outputting the transport stream to the transport stream decoder and allowing the program stream to be recorded in the recording medium; and a system control unit for controlling the transport stream decoder and the program stream encoder to execute TS-PS conversion for converting the transport stream into the program stream, and the system control unit allows the TS-PS conversion to be executed when both of the transport stream decoder and the program stream encoder are available for the TS-PS conversion in consideration of priority of processing of the TS-PS conversion.

Accordingly, even when processing with higher priority than the TS-PS conversion processing is being executed, the TS-PS conversion processing can be proceeded if both of the transport stream decoder and the program stream encoder are available for the TS-PS conversion.

The other data recording/reproducing device of this invention includes a transport stream system decoder for performing first conversion for converting a transport stream into a packetized elementary stream; a stream control unit for allowing the packetized elementary stream to be recorded and reading the recorded packetized elementary stream; a program stream system encoder for performing second conversion for converting the packetized elementary stream read by the stream control unit into a program stream; and a system control unit for controlling the transport stream system decoder to perform the first conversion and controlling the program stream system encoder to perform the second conversion, whereby executing TS-PS conversion for converting the transport stream into the program stream, and the stream control unit reads the transport stream from a recording medium, outputs the read transport stream to the transport stream system decoder and allows the program stream to be recorded in the recording medium, and in consideration of priority of processing of the TS-PS conversion, the system control unit makes the transport stream system decoder perform the first conversion when the transport stream system decoder is available for the TS-PS conversion, and makes the program stream system encoder perform the second conversion when the program stream system encoder is available for the TS-PS conversion.

Accordingly, even when processing with higher priority than the TS-PS conversion processing is being executed, if one of the transport stream system decoder and the program stream system encoder is available for the TS-PS conversion, the first or second conversion can be performed, and therefore, the TS-PS conversion processing can be proceeded.

### Effects of the Invention

According to the present invention, even when there arises conflict in a necessary resource such as a decoder between the TS-PS conversion processing and another processing, if any resource becomes available for the TS-PS conversion, the TS-PS conversion processing can be proceeded. Accordingly, there is no need to perform an operation for making a request for the TS-PS conversion again when a necessary resource is being used or there is no need to perform an operation for halting the TS-PS conversion when processing in conflict in the necessary resource is requested.

### BRIEF DESCRIPTION OF DRAWINGS

FIG. 1 is a block diagram of a data recording/reproducing device according to Embodiment 1 of the invention.

FIG. 2 is a flowchart for showing an exemplified flow of processing performed in the data recording/reproducing device of FIG. 1.

FIG. 3 is a flowchart for showing a modification of the process flow shown in FIG. 2.

FIG. 4 is a flowchart for showing another modification of the process flow shown in FIG. 2.

FIG. 5 is a flowchart for showing still another modification of the process flow shown in FIG. 2.

FIG. 6 is a block diagram of a data recording/reproducing device according to Embodiment 2 of the invention.

FIG. 7 is a flowchart for showing an exemplified flow of processing performed in the data recording/reproducing device of FIG. 6.

FIG. 8 is a flowchart for showing a modification of the process flow shown in FIG. 7.

FIG. 9 is a flowchart for showing another modification of the process flow shown in FIG. 7.

FIG. 10 is a flowchart for showing still another modification of the process flow shown in FIG. 7.

FIG. 11 is a flowchart for showing an exemplified flow of processing of conventional TS-PS conversion.

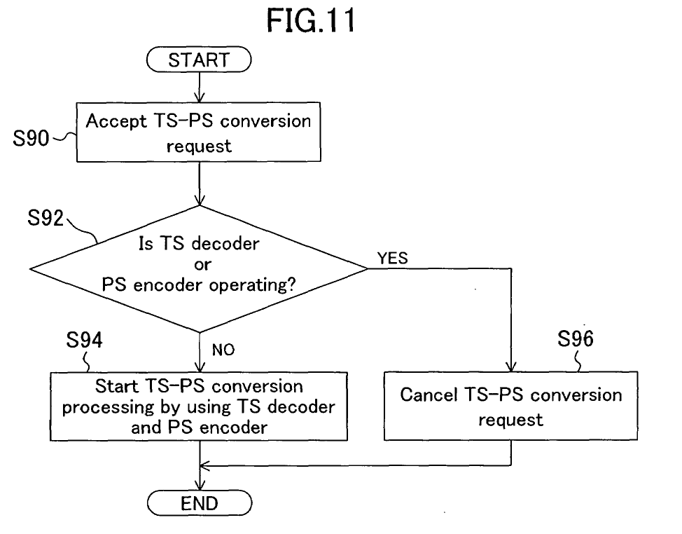

### DESCRIPTION OF REFERENCE NUMERALS

12, 212 system control unit
32 transport stream decoder
38 program stream encoder
42, 242 stream control unit
52 program stream decoder
54 image synthesizing unit
56 recording unit
232 transport stream system decoder
238 program stream system encoder

### BEST MODE FOR CARRYING OUT THE INVENTION

Now, preferred embodiments of the invention will be described with reference to the accompanying drawings.

### Embodiment 1

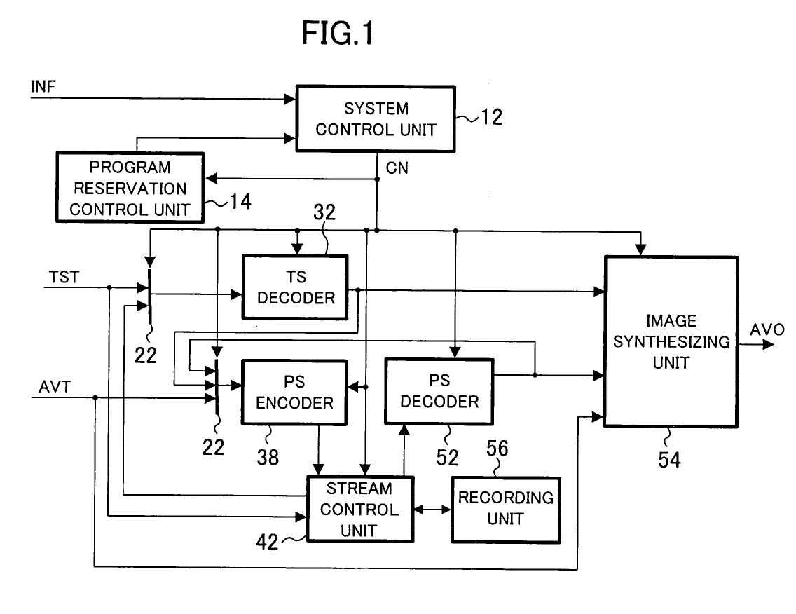

FIG. 1 is a block diagram of a data recording/reproducing device according to Embodiment 1 of the invention. The data recording/reproducing device of FIG. 1 includes a system control unit 12, a program reservation control unit 14, a first selector 22, a second selector 24, a transport stream (TS) decoder 32, a program stream (PS) encoder 38, a stream control unit 42, a PS decoder 52, an image synthesizing unit 54 and a recording unit 56.

The data recording/reproducing device of FIG. 1 constructs a DVD/HDD recorder system having a DTV receiving function (hereinafter referred to as a DTV/DVD recorder) together with a digital tuner (not shown) for receiving DTV broadcasting and an analog tuner (not shown) for receiving analog television broadcasting.

The recording unit 56 of FIG. 1 writes data in a recording medium and reads data from a recording medium. Examples of the recording medium are a writable DVD and an HDD. Alternatively, a storage device such as a flush memory or an SDRAM (synchronous dynamic random access memory) may be used as the recording medium. In other words, the recording unit 56 is specifically a DVD drive, an HDD, a memory card reader/writer or the like, in which a DVD, a flush memory or the like is removable. A plurality of kinds of recording media may be combined for use. Furthermore, a recording medium from which TS data or the like is read and a recording medium in which PS data or the like is written may be the same or different. Also, a recording medium to be used may be exchanged in the middle of an operation.

The system control unit 12 controls the whole DTV/DVD recorder. Specifically, the system control unit 12 controls data flow between respective components, gains operation information of the respective components and starts/halts an operation in accordance with operation information INF supplied by a user. The program reservation control unit 14 outputs, in accordance with set program reservation information, a start/halt signal for a reproducing or recording operation to the system control unit 12.

The TS decoder 32 obtains a PES from an input TS, obtains ESs of audio and video signals or the like from the obtained PES, decodes the thus obtained ESs and outputs the resultant as an AV signal. The PS encoder 38 encodes an audio signal and a video signal included in an input AV signal for obtaining ESs of them, obtains PESs from the respective ESs, and further obtains PSs for outputting them to the stream control unit 42.

The stream control unit 42 outputs a TS output from the digital tuner and a PS output from the PS encoder 38 to the recording unit 56 to be recorded. The recording unit 56 writes a TS and a PS output from the stream control unit 42 in a recording medium such as a DVD or an HDD. The stream control unit 42 reads a TS or a PS having been written in a recording medium from the recording unit 56, and outputs the TS to the first selector 22 and the PS to the PS decoder 52.

The PS decoder 52 obtains a PES from a PS output from the stream control unit 42, obtains ESs of audio and video signals or the like from the obtained PES, decodes the thus obtained ESs for outputting the resultant as an AV signal. The image synthesizing unit 54 synthesizes AV signals output from the analog tuner, the TS decoder 32 and the PS decoder 52 and character video information output from the system control unit 12 and outputs the resultant as an AV signal AVO.

The first selector 22 selects, in accordance with a control signal CN output from the system control unit 12, either a transport stream TST output from the digital tuner or a TS output from the stream control unit 42 for outputting it to the TS decoder 32. The second selector 24 selects, in accordance with the control signal CN output from the system control unit 12, one of an AV signal AVT output from the analog tuner, an AV signal output from the TS decoder 32 and an AV signal output from the PS decoder 52 for outputting it to the PS encoder 38.

As an exemplified operation, a recording operation for the analog broadcasting will be described. The second selector 24 selects an AV signal AVT output from the analog tuner and outputs it to the PS encoder 38. The PS encoder 38 encodes the input AV signal AVT and outputs the thus obtained PS to the stream control unit 42. The stream control unit 42 outputs the input PS to the recording unit 56 to be recorded. In this manner, the system control unit 12 controls the respective components so as to record the analog broadcasting.

Next, the TS-PS conversion processing for format conversion of a TS into a PS will be described. The stream control unit 42 reads a TS recorded in a recording medium from the recording unit 56 and outputs it to the first selector 22. The first selector 22 selects the TS output from the stream control unit 42 and outputs it to the TS decoder 32. The TS decoder 32 decodes the input TS and outputs the thus obtained AV signal to the second selector 24. The second selector 24 selects the AV signal output from the TS decoder 32 and outputs it to the PS encoder 38. The PS encoder 38 encodes the input AV signal and outputs the thus obtained PS to the stream control unit 42. The stream control unit 42 outputs the input PS to the recording unit 56 for recording it in a recording medium.

Since the TS decoder 32 and the PS encoder 38 are used in the TS-PS conversion in this manner, in the case where the TS decoder 32 is to be used in reproducing a TS or the PS encoder 38 is to be used in recording a PS, there arises conflict in a resource of the TS decoder 32 or the PS encoder 38. Accordingly, it is necessary to control the data recording/reproducing device in accordance with the use condition of the resources of the TS decoder 32 and the PS encoder 38.

Therefore, the system control unit 12 allows, in consideration of the priority of the TS-PS conversion processing, the TS decoder 32 and the PS encoder 38 to execute the TS-PS conversion in the case where both of the TS decoder 32 and the PS encoder 38 are available for the TS-PS conversion.

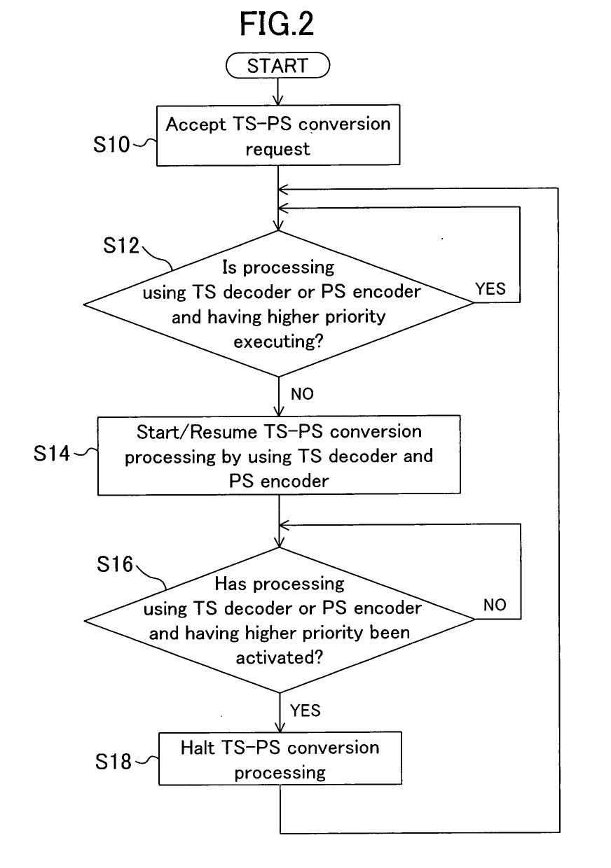

FIG. 2 is a flowchart for showing the flow of processing executed in the data recording/reproducing device of FIG. 1. Hereinafter, it is assumed that TS reproducing processing in accordance with an operation by a user, analog picture recording processing in accordance with an operation by a user and analog picture recording processing in accordance with reservation have higher priority than the TS-PS conversion processing. In the TS reproducing processing in accordance with an operation by a user, the resource of the TS decoder 32 is used. Also, in the analog picture recording processing in accordance with an operation by a user and the analog picture recording processing in accordance with reservation, the resource of the PS encoder 38 is used.

In step S10 of FIG. 2, the system control unit 12 accepts a TS-PS conversion request through an operation by a user.

In step S12, the system control unit 12 determines whether or not processing using the TS decoder 32 or the PS encoder 38 and having higher priority than the TS-PS conversion is being executed. In other words, it is determined whether or not the TS reproducing processing in accordance with an operation, the analog picture recording processing in accordance with an operation or the analog picture recording processing in accordance with reservation is being executed. In the case where none of these processing is being executed, namely, in the case where neither the TS decoder 32 nor the PS encoder 38 is operating, the procedure proceeds to step S84. In the case where any of these processing is being executed, namely, in the case where at least one of the TS decoder 32 and the PS encoder 38 is operating, the procedure returns to step S12, so as to wait until the resource is available by repeatedly making this determination.

In step S14, the system control unit 12 starts or resumes the aforementioned TS-PS conversion processing by using the TS decoder 32 and the PS encoder 38.

In step S16, the system control unit 12 determines whether or not processing using the TS decoder 32 or the PS encoder 38 and having higher priority than the TS-PS conversion has been activated. In other words, it is determined whether or not the TS reproducing processing in accordance with an operation, the analog picture recording processing in accordance with an operation or the analog picture recording processing in accordance with reservation has been activated. In the case where any of these processing has been activated, the procedure proceeds to step S18. In the case where none of these processing has been activated, the procedure returns to step S16, and the TS-PS conversion processing is continuously executed while repeatedly checking the start of use of the resources in any processing with higher priority.

In step S18, the system control unit 12 halts the TS-PS conversion processing and the procedure returns to step S12.

In this manner, the device of FIG. 1 intermittently continues the TS-PS conversion processing in accordance with the priority of the processing, and therefore, even in the case where processing in conflict in a resource is requested, the TS-PS conversion processing can be continuously executed by utilizing time when the resource is available without performing the operation again.

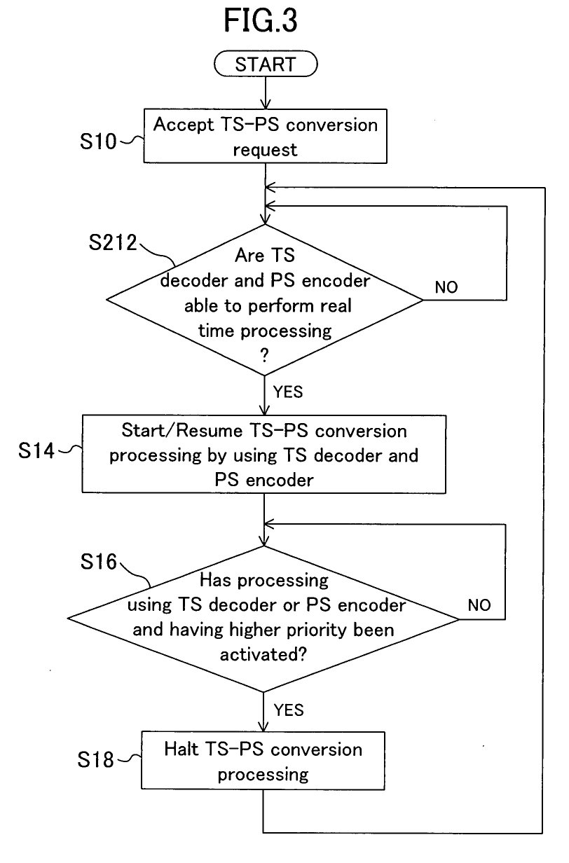

FIG. 3 is a flowchart for showing a modification of the process flow of FIG. 2. In the flowchart of FIG. 3, step S12 of the flowchart of FIG. 2 is replaced with step S212. The other steps are the same as those described with reference to FIG. 2 and hence the description is omitted. In this case, it is assumed that the TS decoder 32 can decode a plurality of TSs in parallel, and that the PS encoder 38 can encode a plurality of AV signals in parallel.

In step S212, the system control unit 12 determines whether or not real time processing can be performed by the TS decoder 32 and the PS encoder 38. In the case where real time processing can be performed by both of the TS decoder 32 and the PS encoder 38, the procedure proceeds to step S14. In the case where real time processing cannot be performed by at least one of the TS decoder 32 and the PS encoder 38, the procedure returns to step S212, so as to wait until the resource is available by repeatedly making this determination.

In this manner, in the process flow shown in FIG. 3, in the case where there remain any resources of the TS decoder 32 and the PS encoder 38 and real time processing can be performed, the TS-PS conversion processing can be executed.

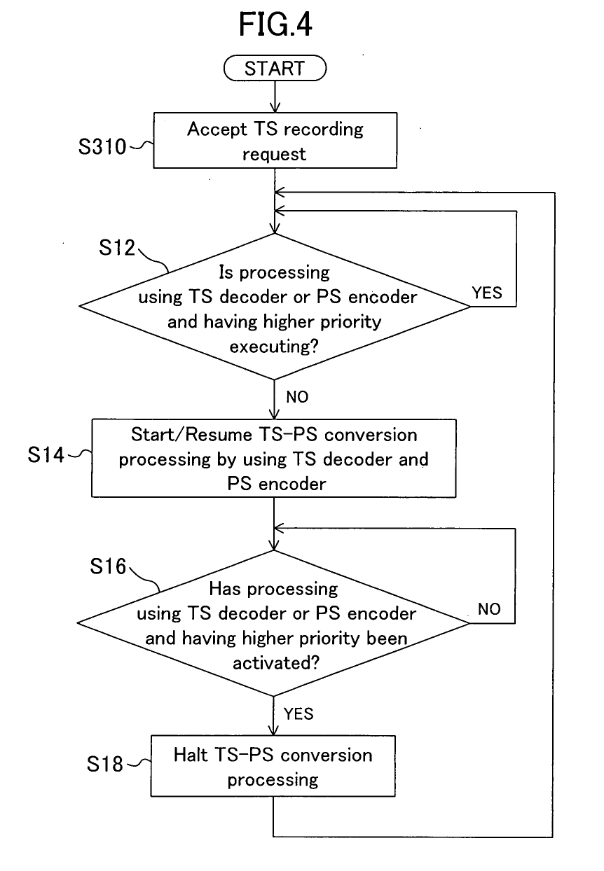

FIG. 4 is a flowchart for showing another modification of the process flow of FIG. 2. In the flowchart of FIG. 4, step S10 of the flowchart of FIG. 2 is replaced with step S310. The other steps are the same as those described with reference to FIG. 2 and hence the description is omitted.

In step S310, the system control unit 12 accepts a TS recording request made through an operation by a user. A TS recording request is a request for recording a TS received by the digital tuner. When a TS recording request is accepted, the stream control unit 42 starts a process for outputting a TS output from the digital tuner to be recorded by the recording unit 56 under control of the system control unit 12. Furthermore, the system control unit 12 executes the TS-PS conversion processing in steps S12, S14, S16 and S18 in the same manner as in FIG. 2 even when a request for the TS-PS conversion is not made.

In this manner, in the process flow of FIG. 4, the TS-PS conversion is automatically executed when the TS recording processing is activated, and hence, a PS is recorded to be used even when a user does not intentionally request the TS-PS conversion.

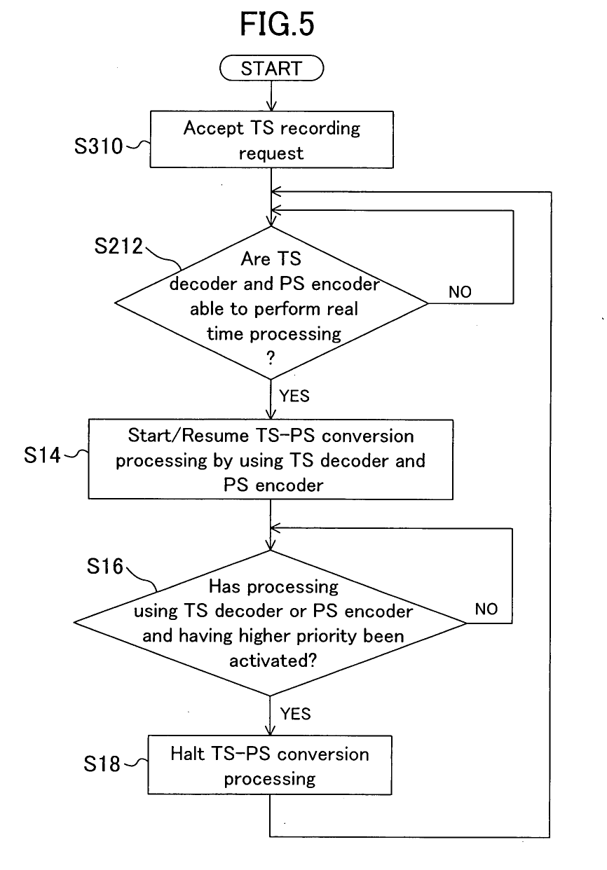

FIG. 5 is a flowchart for showing still another modification of the process flow of FIG. 2. In the flowchart of FIG. 5, step S10 of the flowchart of FIG. 3 is replaced with step S310. The other steps are the same as those described with reference to FIG. 3 and hence the description is omitted. Step S310 is the same as that described with reference to FIG. 4. In this case, it is assumed that the TS decoder 32 can decode a plurality of TSs in parallel and that the PS encoder 38 can encode a plurality of AV signals in parallel.

In the process flow of FIG. 5, in the case where there remain any resources of the TS decoder 32 and the PS encoder 38 and real time processing can be executed, if the TS recording processing is performed, the TS-PS conversion processing is executed so that a PS can be used even when a user does not intend to.

In the process flow of FIG. 4 or 5, the system control unit 12 may be constructed so that it can be determined whether or not the TS-PS conversion processing is to be executed in accordance with an instruction of a user supplied as operation information INF.

### Embodiment 2

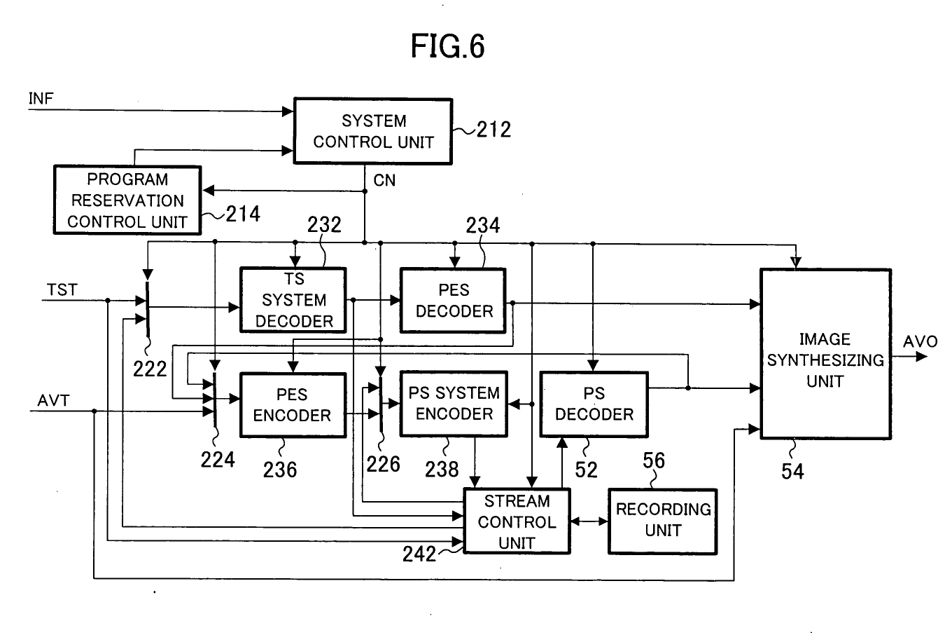

FIG. 6 is a block diagram of a data recording/reproducing device according to Embodiment 2 of the invention. The data recording/reproducing device of FIG. 6 includes a system control unit 212, a program reservation control unit 214, a first selector 222, a second selector 224, a third selector 226, a TS system decoder 232, a PES decoder 234, a PES encoder 236, a PS system encoder 238, a stream control unit 242, a PS decoder 52, an image synthesizing unit 54, and a recording unit 56.

The data recording/reproducing device of FIG. 6 constructs a DVD/HDD recorder system (DTV/DVD recorder) having the DTV receiving function together with a digital tuner (not shown) for receiving the DTV broadcasting and an analog tuner (not shown) for receiving the analog television broadcasting. The PS decoder 52, the image synthesizing unit 54 and the recording unit 56 are the same as those described with reference to FIG. 1 and hence the description is omitted.

The system control unit 212 controls the whole DTV/DVD recorder. Specifically, the system control unit 212 controls data flow between respective components, gains operation information of the respective components and starts/halts an operation in accordance with operation information INF supplied by a user. The program reservation control unit 214 outputs, in accordance with set program reservation information, a start/halt signal for a reproducing or recording operation to the system control unit 212.

The TS system decoder 232 obtains a PES from an input TS and outputs the thus obtained PES. The PES decoder 234 obtains ESs of audio and video signals or the like from the PES obtained by the TS system decoder 232, decodes the ESs and outputs them as an AV signal. The PES encoder 236 encodes an audio signal and a video signal included in an input AV signal for obtaining ESs of the respective signals, and obtains respective PESs from the ESs for outputting them. The PS system encoder 238 obtains a PS from an input PES and outputs it to the stream control unit 242.

The stream control unit 242 outputs a TS output from the digital tuner, a PES output from the TS system decoder 232 and a PS output from the PS system encoder 238 to the recording unit 56 for recording them. The recording unit 56 writes the TS, the PES and the PS output from the stream control unit 242 in a recording medium such as a DVD or an HDD. Also, the stream control unit 242 reads a TS, a PES or a PS written in a recording medium from the recording unit 56, outputs the TS to the first selector 222, outputs the PES to the third selector 226 and outputs the PS to the PS decoder 52.

The first selector 222 selects one of a transport stream TST output from the digital tuner and a TS output from the stream control unit 242 in accordance with a control signal CN output by the system control unit 212, and outputs it to the TS system decoder 232. The second selector 224 selects one of an AV signal AVT output from the analog tuner, an AV signal output from the PES decoder 234 and an AV signal output from the PS decoder 52 in accordance with the control signal CN output by the system control unit 212, and outputs it to the PES encoder 236. The third selector 226 selects one of a PES output from the PES encoder 236 and a PES output from the stream control unit 242 in accordance with the control signal CN output by the system control unit 212, and outputs the selected one to the PS system encoder 238.

Next, TS-PES conversion processing will be described. The stream control unit 242 reads a TS recorded in a recording medium from the recording unit 56 and outputs it to the first selector 222. The first selector 222 selects the TS output from the stream control unit 242 and outputs it to the TS system decoder 232. The TS system decoder 232 converts the input TS into a PES and outputs it to the stream control unit 242. The stream control unit 242 outputs the PES output from the TS system decoder 232 to the recording unit 56 for recording it in a recording medium.

Furthermore, PES-PS conversion processing will be described. The stream control unit 242 reads a PES recorded in a recording medium from the recording unit 56 and outputs it to the third selector 226. The third selector 226 selects the PES output from the stream control unit 242 and outputs it to the PS system encoder 238. The PS system encoder 238 converts the input PES into a PS and outputs it to the stream control unit 242. The stream control unit 242 outputs the input PS to the recording unit 56 for recording it in a recording medium.

In this manner, the TS system decoder 232 is used in the TS-PES conversion and the PS system encoder 238 is used in the PES-PS conversion. Therefore, in the case where the TS system decoder 232 is to be used in reproducing a TS or the PS system encoder 238 is to be used in recording a PS, there arises conflict in a resource of the TS system decoder 232 or the PS system encoder 238. Accordingly, it is necessary to control the data recording/reproducing device in accordance with the use condition of the resources of the TS system decoder 232 and the PS system encoder 238.

Therefore, the system control unit 212 allows, in consideration of the priority of the TS-PS conversion processing, the TS system decoder 232 to execute the TS-PES conversion in the case where the TS system decoder 232 is available for the TS-PS conversion, and the PS system encoder 238 to execute the PES-PS conversion in the case where the PS system encoder 238 is available for the TS-PS conversion.

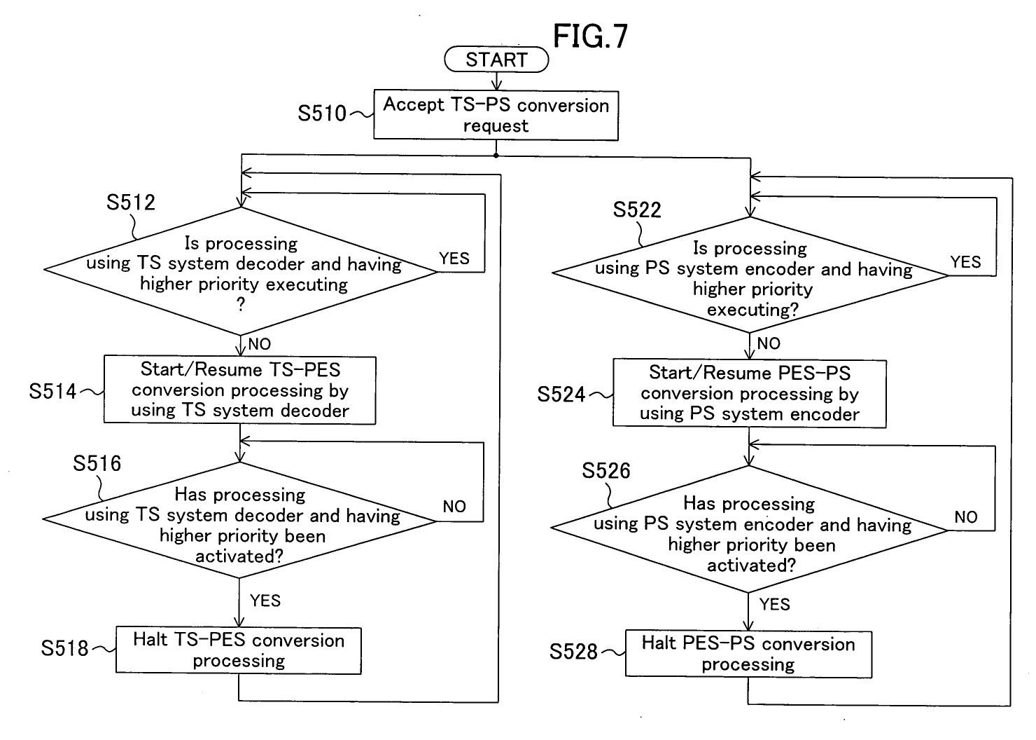

FIG. 7 is a flowchart for showing the flow of processing executed in the data recording/reproducing device of FIG. 6. Hereinafter, it is assumed that TS reproducing processing in accordance with an operation by a user, analog picture recording processing in accordance with an operation by a user and analog picture recording processing in accordance with reservation have higher priority than the TS-PS conversion processing. In the TS reproducing processing in accordance with an operation by a user, the resource of the TS system decoder 232 is used. Also, in the analog picture recording processing in accordance with an operation by a user and the analog picture recording processing in accordance with reservation, the resource of the PS system encoder 238 is used.

In step S510 of FIG. 7, the system control unit 212 accepts a TS-PS conversion request made through an operation by a user.

In step S512, the system control unit 212 determines whether or not processing using the TS system decoder 232 and having higher priority than the TS-PS conversion is being executed. In other words, it is determined whether or not the TS reproducing processing in accordance with an operation is being executed. In the case where this processing is not being executed, namely, in the case where the TS system decoder 232 is not operating, the procedure proceeds to step S514. In the case where the processing is being executed, namely, in the case where the TS system decoder 232 is operating, the procedure returns to step S512, so as to wait until the resource is available by repeatedly making this determination.

In step S514, the system control unit 212 starts or resumes the aforementioned TS-PES conversion processing by using the TS system decoder 232.

In step S516, the system control unit 212 determines whether or not processing using the TS system decoder 232 and having higher priority than the TS-PS conversion has been activated. In other words, it is determined whether or not the TS reproducing processing in accordance with an operation has been activated. In the case where this processing has been activated, the procedure proceeds to step S518. In the case where this processing has not been activated, the procedure returns to step S516, so as to continuously execute the TS-PES conversion processing while repeatedly checking the start of use of the resource in any processing with higher priority.

In step S518, the system control unit 212 halts the TS-PES conversion processing and the procedure returns to step S512.

After accepting the TS-PS conversion request made through an operation by a user in step S510, in step S522, the system control unit 212 determines whether or not processing using the PS system encoder 238 and having higher priority than the TS-PS conversion is being executed. In other words, it is determined whether or not the analog picture recording processing in accordance with an operation or the analog picture recording processing in accordance with reservation is being executed. In the case where none of these processing is being executed, namely, in the case where the PS system encoder 238 is not operating, the procedure proceeds to step S524. In the case where any of these processing is being executed, namely, in the case where the PS system encoder 238 is operating, the procedure returns to the step S522, so as to wait until the resource is available by repeatedly making this determination.

In step S524, after a PES to be processed is recorded by the recording unit 56, the system control unit 212 starts or resumes the aforementioned PES-PS conversion processing by using the PS system encoder 238.

In step S526, the system control unit 212 determines whether or not processing using the PS system encoder 238 and having higher priority than the TS-PS conversion has been activated. In other words, it is determined whether or not the analog picture recording processing in accordance with an operation or the analog picture recording processing in accordance with reservation has been activated. In the case where any of these processing has been activated, the procedure proceeds to step S528. In the case where none of these processing has been activated, the procedure returns to step S526, so as to continuously execute the PES-PS conversion processing while repeatedly checking the start of use of the resource in any processing with higher priority.

In step S528, the system control unit 212 halts the PES-PS conversion processing and the procedure returns to step S522.

In this manner, the device of FIG. 6 intermittently continues the TS-PES conversion processing and the PES-PS conversion processing in accordance with the priority of the processing, and therefore, even in the case where processing in conflict in the resource is requested, the TS-PS conversion processing can be continuously executed by utilizing time when the resource is available without performing the operation again.

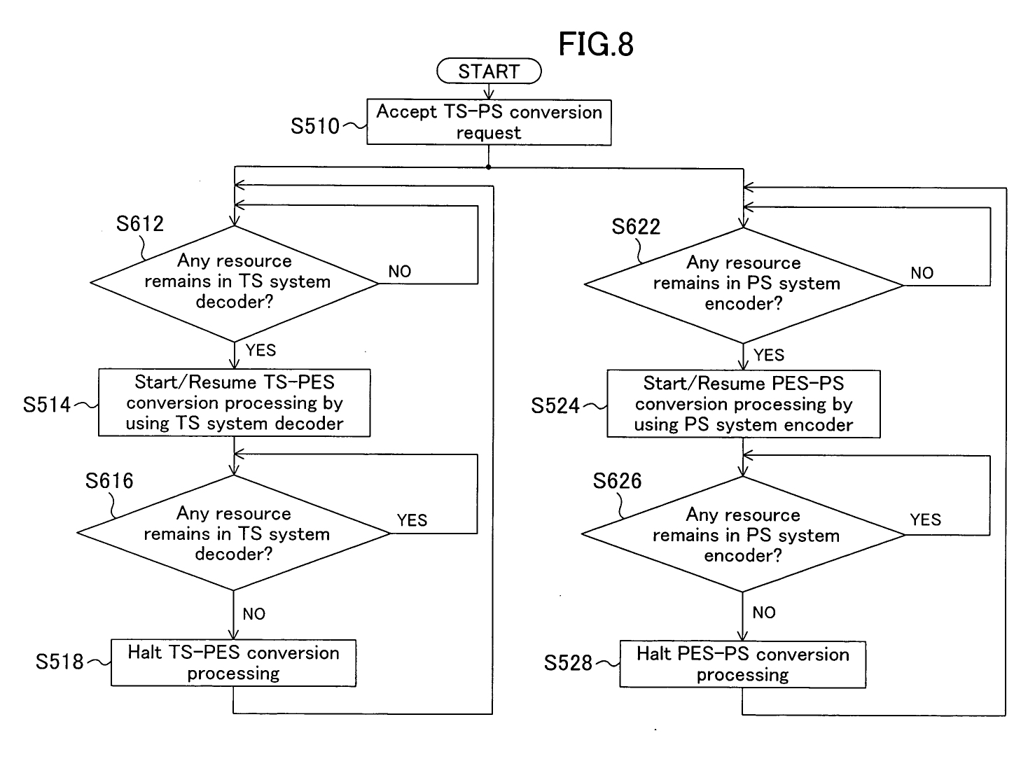

FIG. 8 is a flowchart for showing a modification of the process flow of FIG. 7. In the flowchart of FIG. 8, steps S512, S516, S522 and S526 of the flowchart of FIG. 7 are respectively replaced with steps S612, S616, S622 and S626. The other steps are the same as those described with reference to FIG. 7 and hence the description is omitted. In this case, it is assumed that the TS system decoder 232 can perform TS system decoding of a plurality of TSs in parallel, and that the PS system encoder 238 can perform PS system encoding of a plurality of PESs in parallel.

In step S612, the system control unit 212 determines whether or not there remains any resource of the TS system decoder 232. In the case where there remains any resource of the TS system decoder 232, the procedure proceeds to step S514. In the case where there remains no resource of the TS system decoder 232, the procedure returns to step S612, so as to wait until a resource is available by repeatedly making this determination.

In step S616, the system control unit 212 determines whether or not there remains any resource of the TS system decoder 232. In the case where there remains any resource of the TS system decoder 232, the procedure returns to step S616 so as to continuously execute the TS-PES conversion processing. In the case where there remains no resource of the TS system decoder 232, the procedure proceeds to step S518.

In step S622, the system control unit 212 determines whether or not there remains any resource of the PS system encoder 238. In the case where there remains any resource of the PS system encoder 238, the procedure proceeds to step S524. In the case where there remains no resource of the PS system encoder 238, the procedure returns to step S622, so as to wait until a resource is available by repeatedly making this determination.

In step S626, the system control unit 212 determines whether or not there remains any resource of the PS system encoder 238. In the case where there remains any resource of the PS system encoder 238, the procedure returns to step S626, so as to continuously execute the PES-PS conversion processing. In the case where there remains no resource of the PS system encoder 238, the procedure proceeds to step S528.

In this manner, in the process flow of FIG. 8, the TS-PS conversion processing can be executed when there remains any resource of the TS system decoder 232 or the PS system encoder 238. Also, the TS-PS conversion is performed through the TS-PES conversion and the PES-PS conversion without using a real time AV signal, and hence, the TS-PES conversion and the PES-PS conversion may be slowly performed. In other words, when any resource is available, the TS-PES conversion or the PES-PS conversion can be performed so as to execute the TS-PS conversion.

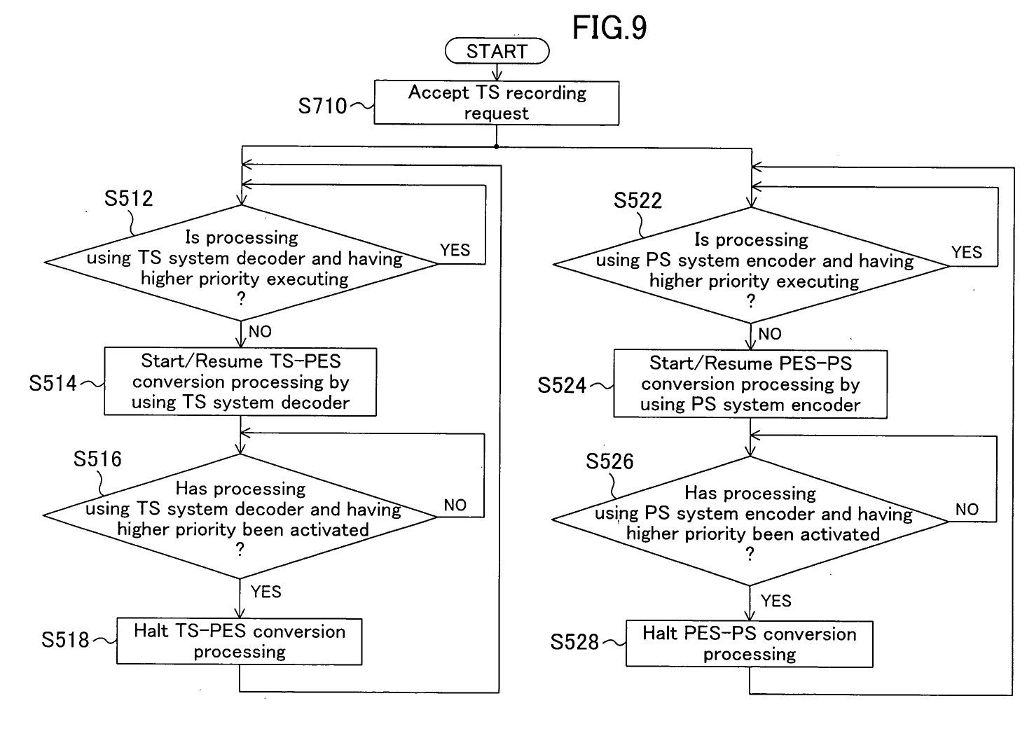

FIG. 9 is a flowchart for showing another modification of the process flow of FIG. 7. In the flowchart of FIG. 9, step S510 of the flowchart of FIG. 7 is replaced with step S710. The other steps are the same as those described with reference to FIG. 7 and hence the description is omitted.

In step S710, the system control unit 212 accepts a TS recording request made through an operation by a user. A TS recording request is a request for recording a TS received by the digital tuner. When a TS recording request is accepted, the stream control unit 242 starts, under control by the system control unit 212, processing for outputting a TS output from the digital tuner to the recording unit 56 to be recorded.

Furthermore, the system control unit 212 executes the TS-PS conversion processing in steps S512, S514, S516, S518, S522, S524, S526 and S528 in the same manner as in FIG. 7 even when a request for the TS-PS conversion is not made. The description of the TS-PS conversion processing is omitted.

In this manner, in the process flow of FIG. 9, the TS-PS conversion is automatically executed when the TS recording processing is activated, and hence, a PS is recorded to be used even when a user does not intentionally request the TS-PS conversion.

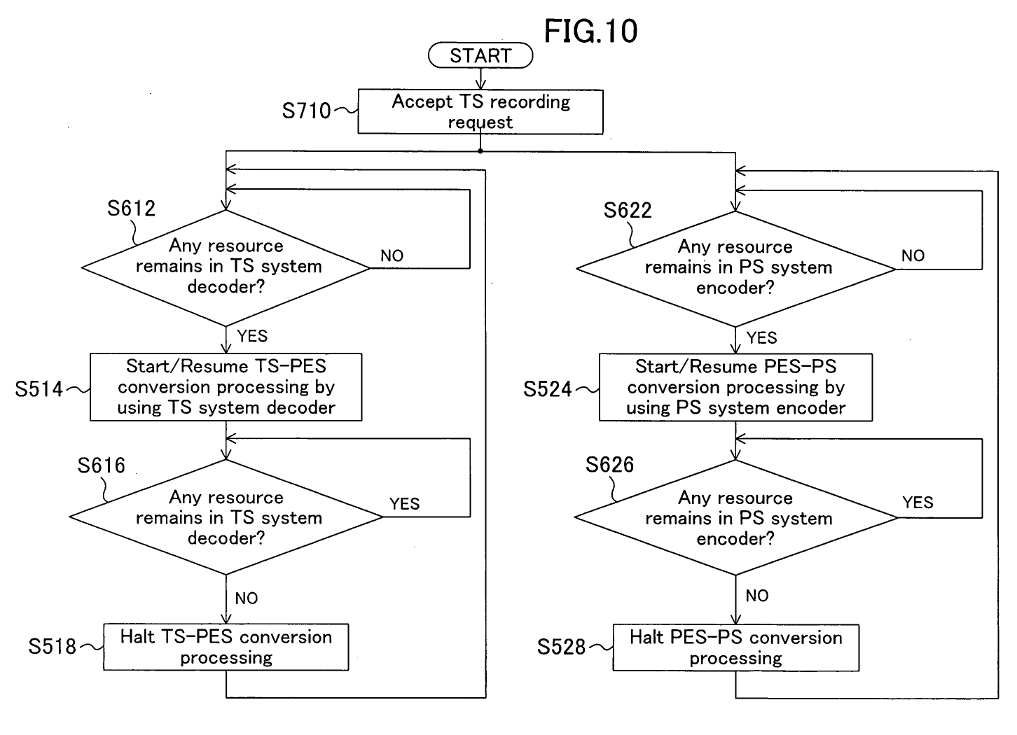

FIG. 10 is a flowchart for showing still another modification of the process flow of FIG. 7. In the flowchart of FIG. 10, step S510 of the flowchart of FIG. 8 is replaced with step S710. Step S710 is the same as that described with reference to FIG. 9 and the other steps are the same as those described with reference to FIG. 8 and hence the description is omitted. In this case, it is assumed that the TS system decoder 232 can perform TS system decoding of a plurality of TSs in parallel and that the PS system encoder 238 can perform PS system encoding of a plurality of PESs in parallel.

In the process flow of FIG. 10, in the case where there remains any resource of the TS system decoder 232 or the PS system encoder 238, if the TS recording processing is performed, the TS-PS conversion processing is executed so that a PS can be used even when a user does not intend to.

In the process flow of FIG. 9 or 10, the system control unit 212 may be constructed so that it can be determined whether or not the TS-PS conversion processing is to be executed in accordance with an instruction of a user supplied as operation information INF.

### INDUSTRIAL APPLICABILITY

As described so far, the TS-PS conversion can be efficiently performed in this invention, and hence, the invention is useful for a DVD/HDD recorder system or the like.

1. A data recording/reproducing device comprising:
a transport stream decoder for decoding a transport stream and outputting a resultant signal;
a program stream encoder for obtaining a program stream by encoding said signal output from said transport stream decoder and outputting said program stream;
a stream control unit for reading said transport stream from a recording medium, outputting said transport stream to said transport stream decoder and allowing said program stream to be recorded in said recording medium; and
a system control unit for controlling said transport stream decoder and said program stream encoder to execute TS-PS conversion for converting said transport stream into said program stream,
wherein said system control unit allows said TS-PS conversion to be executed when both of said transport stream decoder and said program stream encoder are available for said TS-PS conversion in consideration of priority of processing of said TS-PS conversion.

2. The data recording/reproducing device of claim 1,
wherein said system control unit starts said TS-PS conversion when neither said transport stream decoder nor said program stream encoder is executing processing with higher priority than said TS-PS conversion, and halts said TS-PS conversion when at least one of said transport stream decoder and said program stream encoder starts processing with higher priority than said TS-PS conversion.

3. The data recording/reproducing device of claim 1,
wherein said system control unit starts said TS-PS conversion when both of said transport stream decoder and said program stream encoder are able to perform real time processing of said TS-PS conversion in consideration of the priority of the processing, and halts said TS-PS conversion when at least one of said transport stream decoder and said program stream encoder is not able to perform real time processing of said TS-PS conversion in consideration of the priority of the processing.

4. The data recording/reproducing device of claim 1,
wherein said stream control unit allows a received transport stream to be recorded in said recording medium, and
when a request for recording a received transport stream is accepted, said system control unit makes said transport stream decoder and said program stream encoder execute said TS-PS conversion even if a request for said TS-PS conversion is not made.

5. The data recording/reproducing device of claim 4,
wherein said system control unit is able to determine whether or not said TS-PS conversion is to be executed in accordance with an instruction.

6. A data recording/reproducing device comprising:
a transport stream system decoder for performing first conversion for converting a transport stream into a packetized elementary stream;
a stream control unit for allowing said packetized elementary stream to be recorded and reading said recorded packetized elementary stream;
a program stream system encoder for performing second conversion for converting said packetized elementary stream read by said stream control unit into a program stream; and
a system control unit for controlling said transport stream system decoder to perform said first conversion and controlling said program stream system encoder to perform said second conversion, whereby executing TS-PS conversion for converting said transport stream into said program stream,
wherein said stream control unit reads said transport stream from a recording medium, outputs said read transport stream to said transport stream system decoder and allows said program stream to be recorded in said recording medium, and
in consideration of priority of processing of said TS-PS conversion, said system control unit makes said transport stream system decoder perform said first conversion when said transport stream system decoder is available for said TS-PS conversion, and makes said program stream system encoder perform said second conversion when said program stream system encoder is available for said TS-PS conversion.

7. The data recording/reproducing device of claim 6,
wherein said system control unit starts said first conversion when said transport stream system decoder is not executing processing with higher priority than said TS-PS conversion, and halts said first conversion when said transport stream system decoder starts processing with higher priority than said TS-PS conversion, and
said system control unit starts said second conversion when said program stream system encoder is not executing processing with higher priority than said TS-PS conversion, and halts said second conversion when said program stream system encoder starts processing with higher priority than said TS-PS conversion.

8. The data recording/reproducing device of claim 6,
wherein in the case where said transport stream system decoder is executing processing with higher priority than said TS-PS conversion, said system control unit starts said first conversion when said transport stream decoder is able to perform said first conversion and halts said first conversion when said transport stream decoder is not able to perform said first conversion, and
in the case where said program stream system encoder is executing processing with higher priority than said TS-PS conversion, said system control unit starts said second conversion when said program stream system encoder is able to perform said second conversion and halts said second conversion when said program stream system encoder is not able to perform said second conversion.

9. The data recording/reproducing device of claim 6,
wherein said stream control unit allows a received transport stream to be recorded in said recording medium, and
when a request for recording a received transport stream is accepted, said system control unit makes said transport stream system decoder and said program stream system encoder execute said TS-PS conversion even if a request for said TS-PS conversion is not made.

10. The data recording/reproducing device of claim 9,
wherein said system control unit is able to determine whether or not said TS-PS conversion is to be executed in accordance with an instruction.
